(19) United States
(12) Patent Application Publication
(10) Pub. No.: US 2014/0026365 A1
(43) Pub. Date: Jan. 30, 2014

(54) ROTARY SHAFT LOCATING STRUCTURE

(71) Applicant: AN SZU HSU, NEW TAIPEI CITY (TW)

(72) Inventor: AN SZU HSU, NEW TAIPEI CITY (TW)

(73) Assignee: FIRST DOME CORPORATION, NEW TAIPEI CITY (TW)

(21) Appl. No.: 13/558,552

(22) Filed: Jul. 26, 2012

(51) Int. Cl. F16C 11/04

(52) U.S. Cl. 16/337

(57) ABSTRACT

A rotary shaft locating structure includes a pivot pin and a pivotal rotary member. The pivot pin has a pivoted section. A part of the surface of the pivoted section is recessed to form a locating face. The other part of the surface is an arched slide guide face. The pivotal rotary member has a fitting seat defining a pivot hole in which the pivoted section is fitted. The pivot hole has an open section corresponding to the first locating face in communication with outer side. The fitting seat has an elastic abutment section extending to the open section for elastically pressing the locating face to provide a stable elastic locating force for the pivotal rotary member. When the elastic abutment section leaves the locating face to elastically abut against the slide guide face, the elastic abutment section provides a stable resistance against rotation of the pivotal rotary member.

### BACKGROUND OF THE INVENTION

1. Field of the Invention

The present invention relates generally to a rotary shaft locating structure, and more particularly to a rotary shaft locating structure, which can provide a stable resistance against rotation of the pivotal rotary member, whereby the pivotal rotary member can be freely located in a desired angular position.

2. Description of the Related Art

The conventional rotary shaft structure capable of providing suitable rotational torque is generally composed of a pivot pin and a pivot seat enclosing the pivot pin. At least a part of the pivot pin can be mechanically processed to form a pivoted section with a circular cross section. The pivot seat is simply made of a metal board material. One side of the pivot seat is curled to form a pivot hole for elastically enclosing the pivoted section. Accordingly, in rotation, a frictional resistance against the rotation is applied to the pivot pin, whereby the pivot seat can be freely located in any desired angular position. However, in practice, the above structure has some shortcomings as follows:

1. The pivot seat is simply made of a metal board material by bending. Under the limitation of the precision of the mold and the elastic restoring effect of the metal board material, the pivot hole can hardly have a circular cross section with a good roundness. After the pivot pin is mechanically processed, the pivoted section of the pivot pin often has a cross section with an approximately true roundness. Therefore, the pivoted section can hardly fully uniformly contact the wall of the pivot hole. Moreover, the contact section will vary with the relative rotation between the pivot pin and the pivot seat. As a result, the resistance against the rotation is non-uniform. This will lead to unsmoothness of the pivotal rotation and affect the operation precision of the product.

2. Only rotational friction exists between the pivot seat and the pivot pin for temporarily locating the pivot seat or the pivot pin. In practice, in the case that the pivot seat or the pivot pin needs to be securely located in a regular angular position for a long time, another additional more complicated structure is needed to achieve this object. Therefore, the difficulty in designing the product is increased. As a result, the assembling time is prolonged and the manufacturing cost is increased.

It is therefore tried by the applicant to provide a rotary shaft locating structure to overcome the above problems existing in the conventional torque rotary shaft structure.

### SUMMARY OF THE INVENTION

It is therefore a primary object of the present invention to provide a rotary shaft locating structure, which includes at least one locating means in the rotational path of the pivot pin for securely locating the pivot pin in a desired angular position in practical use.

It is a further object of the present invention to provide the above rotary shaft locating structure, which can provide a stable resistance against rotation of the pivot pin, whereby the pivot pin can be freely located in any desired angular position.

It is still a further object of the present invention to provide the above rotary shaft locating structure, which is simplified and easy to assemble at higher efficiency. Therefore, the manufacturing cost is lowered.

To achieve the above objects and efficiency, the rotary shaft locating structure of the present invention includes: a pivot pin having a pivoted section, a part of the surface of the pivoted section being formed with at least one first locating face; and a pivotal rotary member having a fitting seat defining a pivot hole in which the pivoted section of the pivot pin is fitted. The pivot hole has an open section positioned in a position corresponding to the first locating face of the pivoted section in communication with outer side. The fitting seat has at least one elastic abutment section extending to the open sect ion, whereby the elastic abutment section can elastically press the first locating face of the pivoted section through the open section.

In the above rotary shaft locating structure, the pivoted section has a circular cross section and the other part of the surface of the pivoted section is an arched slide guide face.

In the above rotary shaft locating structure, a circumference of the pivoted section is further formed with a second locating face.

In the above rotary shaft locating structure, the second locating face is opposite to the first locating face.

In the above rotary shaft locating structure, the fitting seat further has an abutment face beside the open section corresponding to the second locating face.

In the above rotary shaft locating structure, the first locating face is a plane face.

In the above rotary shaft locating structure, the elastic abutment section is spaced from two sides of the open section of the pivot hole by two splits.

In the above rotary shaft locating structure, the first locating face is formed on a middle section of the pivoted section.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective assembled view of the present invention;

FIG. 3 is a sectional assembled view of the present invention;

FIG. 4 is a sectional view according to FIG. 3, Showing the pivotal rotation of the present invention in one state;

FIG. 5 is a sectional view according to FIG. 3, showing the pivotal rotation of the present invention in another state;

FIG. 6 is a sectional view according to FIG. 3, showing the pivotal rotation of the present invention in still another state; and

FIG. 7 is a sectional view according to FIG. 3, showing that the pivotal rotary member of the present invention is restored to its home position.

### DETAILED DESCRIPTION OF THE PREFERRED EMBODIMENTS

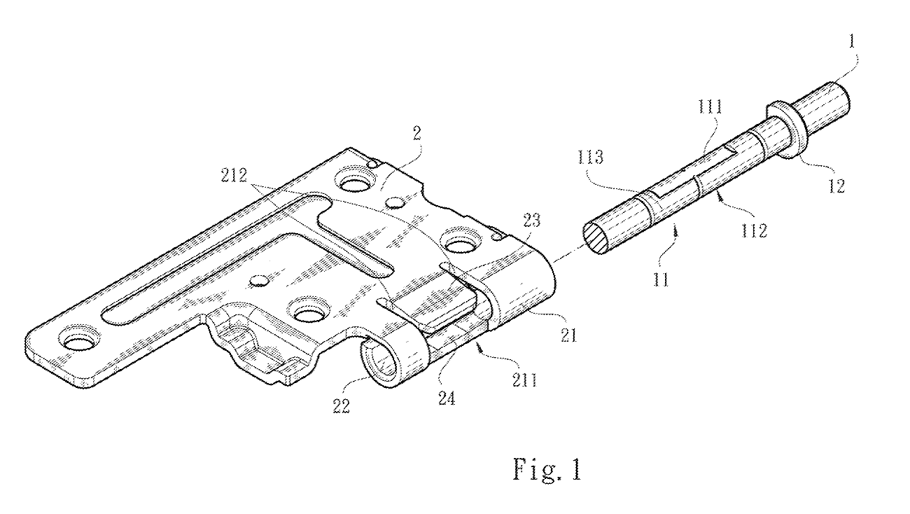

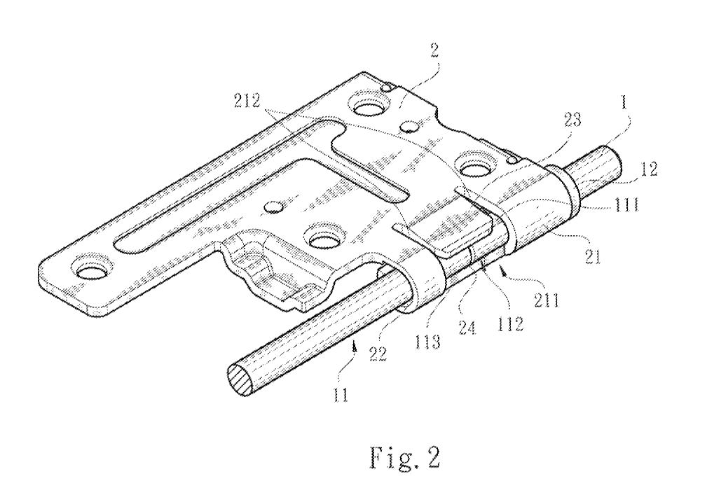

Please refer to FIGS. 1 and 2. The rotary shaft locating structure of the present invention includes a pivot pin 1 and a pivotal rotary member 2. The pivot pin 1 has an annular raised stop section 12 in the middle. A pivoted section 11 with a circular cross section is disposed at one end of the pivot pin 1. A part of the surface of the pivoted section 11 (such as a middle section thereof) is recessed to form at least one first locating face 111, (which can be a plane face). The other part of the surface of the pivoted section 11 is an arched slide guide face 113. One side of the pivotal rotary member 2 is formed with a curled fitting seat 21 defining a pivot hole 22 in which the pivoted section 11 is fitted. The pivot hole 22 has an open section 211 positioned in a position (middle section) corresponding to the first locating face 111 in communication with the outer side. The fitting seat 21 has an elastic abutment section 23 extending to the open section 211. The elastic abutment section 23 is spaced from two sides of the open section 211 by two transversely extending splits 212. Accordingly, the elastic abutment section 23 can normally elastically press the first locating face 111 through the open section 211.

In the above structure, the circumference of the pivoted section 11 can be further formed with a second locating face 112 as necessary, (which can be a plane face opposite to the first locating face 111). The fitting seat 21 further has an abutment face 24 beside the open section 211, (which can be a plane face corresponding to the second locating face 112). Accordingly, when the elastic abutment section 23 presses the first locating face 111, the abutment face 24 also abuts against the second locating face 112.

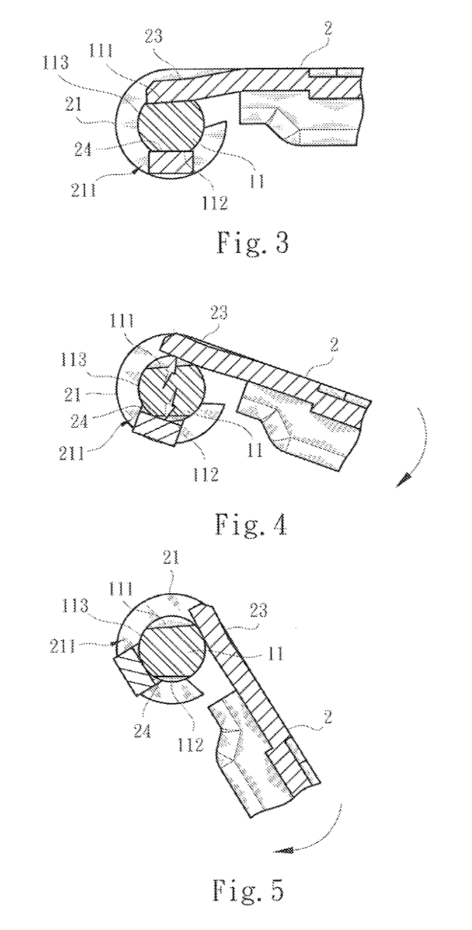

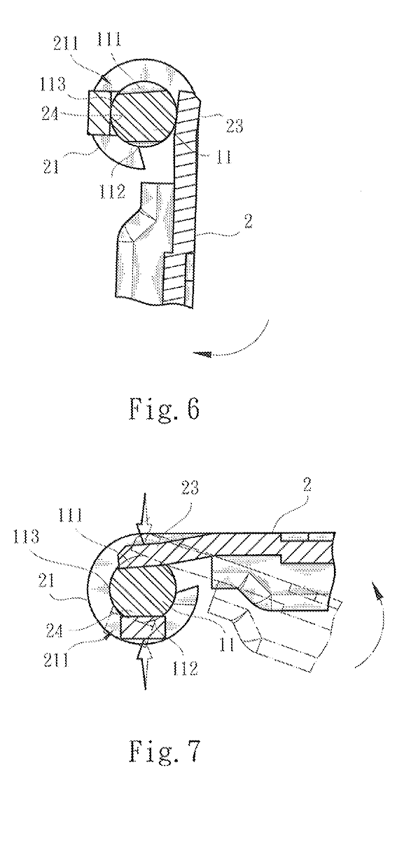

Please refer to FIGS. 3 to 7. In operation, when the pivot pin 1 and the pivotal rotary member 2 are positioned in their home positions, the elastic abutment section 23 of the pivotal rotary member 2 presses the first locating face 111 of the pivot pin 1. (In the meantime, the abutment face 24 abuts against the second locating face 112). Under such circumstance, the pivotal rotary member 2 is located and uneasy to rotate relative to the pivot pin 1 (as shown in FIG. 3). When the pivot pin 1 or the pivotal rotary member 2 is forced and relatively pivotally rotated, the first locating face 111 will bear a sufficient torque to leave the elastic abutment section 23. (In the meantime, the second locating face 112 also leaves the abutment face 24 as shown in FIG. 4). Then the elastic abutment section 23 elastically abuts against the slide guide face 113 on one side, (while the abutment face 24 elastically abuts against the slide guide face 113 on the other side). Accordingly, during the relative rotation between the pivot pin 1 and the pivotal rotary member 2, there is always a stable resistance against the pivotal rotation (as shown in FIGS. 5 and 6). When the pivot pin 1 and the pivotal rotary member 2 are relatively rotated in a reverse direction, after the elastic abutment section 23 leaves the slide guide face 113, due to its own elasticity, the elastic abutment section 23 will inertly slide onto the first locating face 111. (In the meantime, after the abutment face 24 leaves the slide guide face 113, the abutment face 24 will inertly slide onto the second locating face 112). Accordingly, the pivot pin 1 and the pivotal rotary member 2 can automatically restore their home positions to be located therein (as shown in FIG. 7). Therefore, the pivot pin 1 and the pivotal rotary member 2 can be truly located without loosening.

In conclusion, according to the present invention, during the relative rotation between the pivot pin and the pivotal rotary member, there is always a stable resistance against the pivotal rotation for freely locating the pivotal rotary member in a desired angular position.

The above embodiments are only used to illustrate the present invention, not intended to limit the scope thereof. Many modifications of the above embodiments can be made without departing from the spirit of the present invention.

What is claimed is:

1. A rotary shaft locating structure comprising:
a pivot pin having a pivoted section, a part of the surface of the pivoted section being formed with at least one first locating face; and
a pivotal rotary member having a fitting seat defining a pivot hole in which the pivoted section of the pivot pin is fitted, the pivot hole having an open section positioned in a position corresponding to the first locating face of the pivoted section in communication with outer side, the fitting seat having at least one elastic abutment sect ion extending to the open sect ion, whereby the elastic abutment section can elastically press the first locating face of the pivoted section through the open section.

2. The rotary shaft locating structure as claimed in claim 1, wherein the pivoted section has a circular cross section and the other part of the surface of the pivoted section is an arched slide guide face.

3. The rotary shaft locating structure as claimed in claim 1, wherein a circumference of the pivoted section is further formed with a second locating face.

4. The rotary shaft locating structure as claimed in claim 2, wherein a circumference of the pivoted section is further formed with a second locating face.

5. The rotary shaft locating structure as claimed in claim 3, wherein the fitting seat further has an abutment face beside the open section corresponding to the second locating face.

6. The rotary shaft locating structure as claimed in claim 4, wherein the fitting seat further has an abutment face beside the open section corresponding to the second locating face.

7. The rotary shaft locating structure as claimed in claim 3, wherein the second locating face is opposite to the first locating face.

8. The rotary shaft locating structure as claimed in claim 4, wherein the second locating face is opposite to the first locating face.

9. The rotary shaft locating structure as claimed in claim 5, wherein the second locating face is opposite to the first locating face.

10. The rotary shaft locating structure as claimed in claim 1, wherein the elastic abutment section is spaced from two sides of the open section of the pivot hole by two splits.

11. The rotary shaft locating structure as claimed in claim 2, wherein the elastic abutment section is spaced from two sides of the open section of the pivot hole by two splits.

12. The rotary shaft locating structure as claimed in claim 3, wherein the elastic abutment section is spaced from two sides of the open section of the pivot hole by two splits.

13. The rotary shaft locating structure as claimed in claim 4, wherein the elastic abutment section is spaced from two sides of the open section of the pivot hole by two splits.

14. The rotary shaft locating structure as claimed in claim 5, wherein the elastic abutment section is spaced from two sides of the open section of the pivot hole by two splits.

15. The rotary shaft locating structure as claimed in claim 1, wherein the first locating face is formed on a middle section of the pivoted section.

16. The rotary shaft locating structure as claimed in claim 2, wherein the first locating face is formed on a middle section of the pivoted section.

17. The rotary shaft locating structure as claimed in claim 3, wherein the first locating face is formed on a middle section of the pivoted section.

18. The rotary shaft locating structure as claimed in claim 4, wherein the first locating face is formed on a middle section of the pivoted section.

19. The rotary shaft locating structure as claimed in claim 5, wherein the first locating face is formed on a middle section of the pivoted section.

20. The rotary shaft locating structure as claimed in claim 1, wherein the first locating face is a plane face.

21. The rotary shaft locating structure as claimed in claim 2, wherein the first locating face is a plane face.

22. The rotary shaft locating structure as claimed in claim 3, wherein the first and second locating faces are plane faces.

23. The rotary shaft locating structure as claimed in claim 4, wherein the first and second locating faces are plane faces.
